(19) United States
(12) Patent Application Publication
(10) Pub. No.: US 2023/0021364 A1
(43) Pub. Date: Jan. 26, 2023

(54) WIRELESS CHARGING APPARATUS, WIRELESS CHARGING METHOD, AND WIRELESS CHARGING SYSTEM

(71) Applicant: TOYOTA JIDOSHA KABUSHIKI KAISHA, Toyota-shi (JP)

(72) Inventors: Takahiro HIRANO, Gotemba-shi (JP); Shogo TSUGE, Fuji-shi (JP); Ryosuke IKEMURA, Susono-shi (JP); Yohei ARINO, Nagoya-shi (JP); Masaki ITO, Toyota-shi (JP); Yuki TAKAHASHI, Susono-shi (JP)

(73) Assignee: TOYOTA JIDOSHA KABUSHIKI KAISHA, Toyota-shi (JP)

(21) Appl. No.: 17/813,462

(22) Filed: Jul. 19, 2022

(30) Foreign Application Priority Data
Jul. 26, 2021 (JP) 2021-121545

(51) Int. Cl. H02J 50/80; B60L 53/12; H02J 50/10; H02J 50/40; H02J 50/90

(52) U.S. Cl. CPC H02J 50/80; B60L 53/12; H02J 50/10; H02J 50/40; H02J 50/90

(57) ABSTRACT

An ECU of a vehicle performs processing including transmitting a power feeding request during traveling along a power feeding lane, transmitting a vehicle ID when the vehicle is determined as having deviated from the power feeding lane, and transmitting the vehicle ID again when the vehicle is determined as having returned to the power feeding lane. A management server performs processing including starting power feeding when it receives the power feeding request, storing the received vehicle ID, stopping power feeding, and resuming power feeding when it receives again the vehicle ID and when the received vehicle ID matches with the stored vehicle ID.

This nonprovisional application is based on Japanese Patent Application No. 2021-121545 filed with the Japan Patent Office can Jul. 26, 2021, the entire contents of which are hereby incorporated by reference.

### BACKGROUND

### Field

The present disclosure relates to wireless charging for wirelessly charging a power storage mounted on an electrically powered vehicle that is traveling.

### Description of the Background Art

Wireless charging has conventionally been known as a technique to charge a power storage mounted on an electrically powered vehicle. Wireless charging is carried out on a power storage mounted on an electrically powered vehicle, with the use of electric power wirelessly received by a power reception apparatus on a vehicle side without a contact being interposed from a power transmission apparatus connected to a power supply outside the electrically powered vehicle.

Such wireless charging can be carried out, for example, during traveling of the electrically powered vehicle. For example, a power feeding lane is made up by placing a plurality of power transmission apparatuses described above in a road.

When the electrically powered vehicle travels along the power feeding lane, a power transmission apparatus that satisfies such positional relation as being opposed to a power reception apparatus of the electrically powered vehicle among a plurality of power transmission apparatuses transmits electric power. Wireless charging can thus be carried out during traveling of the electrically powered vehicle. The electrically powered vehicle that is traveling along such a power feeding lane is expected to change a lane, for example, for passing or the like. At this time, when the vehicle temporarily deviates from the power feeding lane, an amount of electric power received from the power feeding lane after the vehicle returns to the power feeding lane may be lower than expected.

In order to address such a problem, for example, Japanese Patent Laying-Open No. 2018-061339 discloses a technique to correct, when a vehicle once deviates from a power feeding lane and thereafter returns to the power feeding lane, electric power requested after the vehicle returns to the power feeding lane, based on a time period during which the vehicle has traveled as deviating from the power feeding lane.

### SUMMARY

When the vehicle that has temporarily deviated from the power feeding lane returns to the power feeding lane and then power feeding is resumed through processing similar to that in start of traveling along the power feeding lane, however, it takes time before resumption of power transmission from the power transmission apparatuses, for example, due to stand-by time for accepting an operation by a user. Therefore, an amount of electric power received from the power feeding lane may be lower than expected. Even when requested power is corrected as in the publication described above, time until resumption of power transmission from the power transmission apparatuses cannot be reduced and the problem described above cannot be solved.

An object of the present disclosure is to provide a wireless charging apparatus, a wireless charging method, and a wireless charging system that allow resumption of power feeding with good responsiveness when an electrically powered vehicle that travels as temporarily deviating from a power feeding lane returns to the power feeding lane.

A wireless charging apparatus according to one aspect of the present disclosure is a wireless charging apparatus configured to wirelessly charge a power storage mounted on an electrically powered vehicle. The electrically powered vehicle includes a power reception apparatus that receives electric power from the wireless charging apparatus. The wireless charging apparatus includes a power feeding lane placed along a first lane, the power feeding lane being composed of a plurality of power transmission apparatuses that transmit electric power to the power reception apparatus of the electrically powered vehicle that travels along the first lane, and a controller that controls the plurality of power transmission apparatuses to transmit electric power to the power reception apparatus of the electrically powered vehicle that travels along the power feeding lane when the controller receives a power feeding request from the electrically powered vehicle. The controller stops power transmission by the plurality of power transmission apparatuses to the power reception apparatus of the electrically powered vehicle that has transmitted first identification information on which identification of the electrically powered vehicle can be based, when the controller receives the first identification information from the electrically powered vehicle that moves from the first lane where the electrically powered vehicle receives electric power from the power feeding lane to a second lane where the power transmission apparatuses are not placed. The controller resumes power transmission by the plurality of power transmission apparatuses to the power reception apparatus of the electrically powered vehicle that has transmitted second identification information on which identification of the electrically powered vehicle can be based, when the controller receives the second identification information from the electrically powered vehicle that returns from the second lane to the power feeding lane in the first lane and when the second identification information matches with the first identification information.

Thus, when the electrically powered vehicle temporarily deviates from the power feeding lane and thereafter returns to the power feeding lane, second identification information that matches with the first identification information received when the electrically powered vehicle temporarily deviates from the power feeding lane is received. Thus, power transmission from the power feeding lane to the power reception apparatus is resumed without reception of the power feeding request again. Therefore, charging of the power storage mounted on the electrically powered vehicle can be resumed with good responsiveness.

In one embodiment, when the controller resumes power transmission to the power reception apparatus by the plurality of power transmission apparatuses, the controller resumes power transmission to the power reception apparatus with power transmission apparatuses from a point where the electrically powered vehicle returns to the power feeding lane among the plurality of power transmission apparatuses.

Thus, a power transmission operation by a power transmission apparatus over which the electrically powered vehicle does not pass among the plurality of power transmission apparatuses can be stopped. Therefore, increase in amount of power consumption can be suppressed.

A wireless charging method according to another aspect of the present disclosure is a wireless charging method of wirelessly charging a power storage mounted on an electrically powered vehicle that travels along a power feeding lane placed along a first lane and composed of a plurality of power transmission apparatuses. The electrically powered vehicle includes a power reception apparatus that receives electric power from the power feeding lane. The wireless charging method includes controlling the plurality of power transmission apparatuses to transmit electric power to the power reception apparatus of the electrically powered vehicle that travels along the power feeding lane in response to reception of a power feeding request from the electrically powered vehicle, stopping power transmission by the plurality of power transmission apparatuses to the power reception apparatus of the electrically powered vehicle that has transmitted first identification information on which identification of the electrically powered vehicle can be based, when the first identification information is received from the electrically powered vehicle that moves from the first lane where electric power is received from the power feeding lane to a second lane where the power transmission apparatuses are not placed, and resuming power transmission by the plurality of power transmission apparatuses to the power reception apparatus of the electrically powered vehicle that has transmitted second identification information on which identification of the electrically powered vehicle can be based, when the second identification information is received from the electrically powered vehicle that returns from the second lane to the power feeding lane in the first lane and when the second identification information matches with the first identification information.

In one embodiment, the wireless charging method further includes resuming power transmission to the power reception apparatus with power transmission apparatuses from a point where the electrically powered vehicle returns to the power feeding lane among the plurality of power transmission apparatuses when power transmission to the power reception apparatus by the plurality of power transmission apparatuses is resumed.

A wireless charging system according to yet another aspect of the present disclosure includes a power feeding lane placed along a first lane and composed of a plurality of power transmission apparatuses, an electrically powered vehicle including a power reception apparatus that receives electric power from the power feeding lane and a power storage configured to be chargeable with received electric power, and a controller that controls the plurality of power transmission apparatuses to transmit electric power to the power reception apparatus of the electrically powered vehicle that travels along the power feeding lane when the controller receives a power feeding request from the electrically powered vehicle. When the electrically powered vehicle moves from the first lane where the electrically powered vehicle receives electric power from the power feeding lane to a second lane where the power transmission apparatuses are not placed, the electrically powered vehicle transmits first identification information on which identification of the electrically powered vehicle can be based to the controller. When the controller receives the first identification information, the controller stops power transmission by the plurality of power transmission apparatuses to the power reception apparatus of the electrically powered vehicle that has transmitted the first identification information. When the electrically powered vehicle returns from the second lane to the power feeding lane in the first lane, the electrically powered vehicle transmits second identification information on which identification of the electrically powered vehicle can be based to the controller. When the controller receives the second identification information and when the second identification information matches with the first identification information, the controller resumes power transmission by the plurality of power transmission apparatuses to the power reception apparatus of the electrically powered vehicle that has transmitted the second identification information.

In one embodiment, when the controller resumes power transmission to the power reception apparatus by the plurality of power transmission apparatuses, the controller resumes power transmission to the power reception apparatus with power transmission apparatuses from a point where the electrically powered vehicle returns to the power feeding lane among the plurality of power transmission apparatuses.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing an exempla configuration of a wireless charging system according to the present embodiment.

FIG. 2 is a diagram showing an exemplary configuration of a vehicle.

FIG. 3 is a diagram for illustrating an exemplary configuration of a power transmission apparatus and a power reception apparatus.

FIG. 4 is a diagram for illustrating an exemplary operation of a vehicle that is traveling along a power feeding lane.

FIG. 5 is a flowchart showing exemplary processing performed in each of a management server and the vehicle.

FIG. 6 is a diagram for illustrating exemplary operations of the management server and the vehicle.

FIG. 7 is a diagram for illustrating exemplary operations of the management server and the vehicle in a modification.

### DESCRIPTION OF THE PREFERRED EMBODIMENTS

An embodiment of the present disclosure will be described below in detail with reference to the drawings. The same or corresponding elements in the drawings have the same reference characters allotted and description thereof will not be repeated.

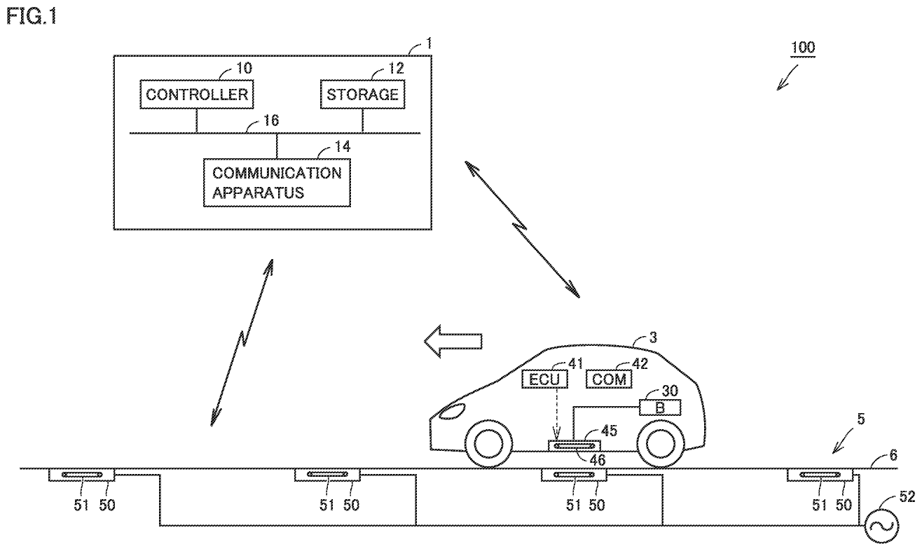

FIG. 1 is a diagram showing an exemplary configuration of a wireless charging system 100 according to the present embodiment. Wireless charging system 100 includes a management server (controller) 1, a vehicle 3, and a power feeding lane 5. Power feeding lane 5 is composed of a plurality of power transmission apparatuses 50 provided tinder the ground of a road 6 where vehicle 3 can travel, and wirelessly supplies electric power to vehicle 3 that travels along power feeding lane 5. A wireless charging apparatus according to the present embodiment is constituted of management server 1 and power feeding lane 5.

Each of the plurality of power transmission apparatuses 50 includes a power transmission coil 51. Vehicle 3 includes a power reception apparatus 45 including a power reception coil 46, and wirelessly receives electric power from power transmission coil 51 by traveling along power feeding lane 5 (by traveling over power transmission apparatus 50). Management server 1 manages vehicle 3 and power feeding lane 5. Management server 1 activates power transmission apparatus 50 in power feeding lane 5 in response to a power feeding request from vehicle 3 that enters power feeding lane 5 to supply electric power to vehicle 3 (power reception apparatus 45).

Management server 1 is a computer including a controller 10, a storage 12, and a communication apparatus 14. Controller 10, storage 12, and communication apparatus 14 are connected through a communication bus 16. Management server 1 corresponds to the “controller” that controls the plurality of power transmission apparatuses 50.

Controller 10 is implemented, for example, by an integrated circuit including, a central processing unit (CPU). Controller 10 is configured to perform prescribed computing processing described in a program.

Storage 12 includes a read only memory (ROM) and a random access memory (RAM). For example, a program executed by controller 10 is stored in the ROM. For example, data generated by execution of a program by controller 10 and data provided through communication apparatus 14 are temporarily stored in the RAM. The RAM functions also as a temporary data memory used as a work area.

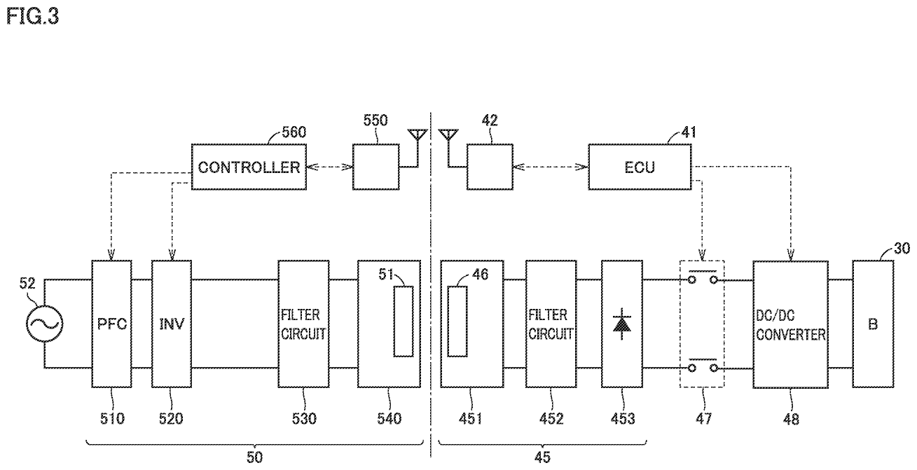

Communication apparatus 14 is configured to bidirectionally communicate with an external device. The external device includes, for example, a communication apparatus 42 of vehicle 3 and a communication apparatus 550 (FIG. 3) of each power transmission apparatus 50 included in power feeding lane 5. Communication apparatus 14 and the external device communicate with each other, for example, wirelessly.

Controller 10 obtains position information, information on a vehicle ID, and information on fed power from vehicle 3 through communication apparatus 14. The position information is obtained, for example, from vehicle 3 every prescribed control cycle. Controller 10 may sense entry of vehicle 3 in the power feeding lane, for example, based on the position information.

The information on the vehicle ID and the information on fed power are sent, for example, from vehicle 3 to management server 1 when vehicle 3 enters power feeding lane 5 and requests power feeding from power feeding lane 5. The information on the vehicle ID is identification information for uniquely specifying vehicle 3 and may be, for example, a vehicle identification number (VIN). The information on fed power indicates electric power which vehicle 3 desires to obtain from power feeding lane 5. When controller 10 receives the power feeding request from vehicle 3, it controls each of the plurality of power transmission apparatuses to set such a state that the plurality of power transmission apparatuses included in power feeding lane 5 can transmit electric power (which will be described as an on state below) based on the information on fed power.

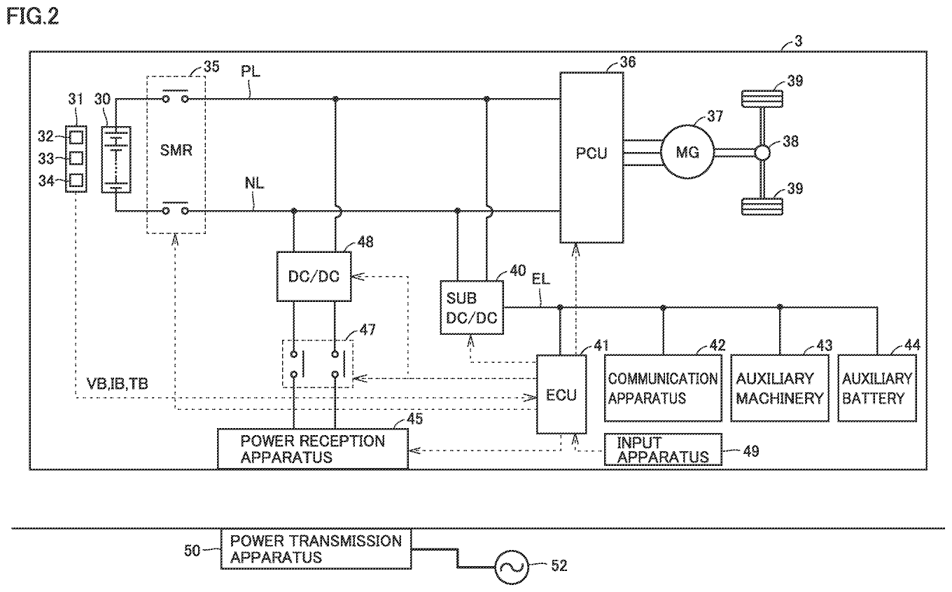

Vehicle 3 should only be an electrically powered vehicle, and it may be an electric vehicle or a hybrid electric vehicle. FIG. 2 is a diagram showing an exemplary configuration of vehicle 3.

Referring to FIGS. 1 and 2, vehicle 3 includes a battery 30, a monitoring unit 31, a system main relay (SMR) 35, a power control unit (PCU) 36, a motor generator (MG) 37, a transmission gear 38, a drive wheel 39, a sub direct-current (DC)/DC converter 40, an electronic control unit (ECU) 41, communication apparatus 42, auxiliary machinery 43, an auxiliary battery 44, and an input apparatus 49.

Battery 30 is mounted as a drive power source (that is, a motive power source) of vehicle 3. Battery 30 includes a plurality of stacked cells. The cell is, for example, a secondary battery such as a nickel metal hydride battery or a lithium ion battery. The cell may be a cell containing a liquid electrolyte between a positive electrode and a negative electrode or a cell (an all-solid-state battery) containing a solid electrolyte. Instead of battery 30, a power storage such as a capacitor may be employed. Monitoring unit 31 monitors a state of battery 30. Monitoring unit 31 includes a voltage sensor 32, a current sensor 33, and a temperature sensor 34. Voltage sensor 32 detects a voltage (battery voltage) VB of battery 30 and outputs a signal indicating a result of detection to ECU 41. Current sensor 33 detects an input and output current (battery current) IB of battery 30 and outputs a signal indicating a result of detection to ECU 41. Temperature sensor 34 detects a temperature (battery temperature) TB of battery 30 and outputs a signal indicating a result of detection to ECU 41.

SMR 35 is electrically connected to power lines PL and NL through which PCU 36 and battery 30 are connected to each other. When SMR 35 is closed, electric power is supplied from battery 30 to PCU 36. When SMR 35 is open, electric power is not supplied from battery 30 to PCU 36. SMR 35 switches between the closed state and the open state in accordance with a control signal from ECU 41.

PCU 36 converts DC power stored in battery 30 into alternating-current (AC) power and supplies resultant AC power to MG 37 in accordance with a control signal from ECU 41. PCU 36 converts AC power generated by MG 37 into DC power and supplies resultant DC power to battery 30. PCU 36 includes, for example, an inverter and a converter that boosts a DC voltage supplied to the inverter to a voltage not lower than an output voltage of battery 30.

MG 37 is, for example, a three-phase AC synchronous motor having a permanent magnet embedded in a rotor. MG 37 is driven by PCU 36 to generate rotational driving force. Driving force generated by MG 37 is transmitted to drive wheel 39 through transmission gear 38.

Sub DC/DC converter 40 is electrically connected between power lines PL and NE and a low-voltage line EL. Sub DC/DC converter 40 lowers a voltage of electric power between power lines PL and NL and supplies the resultant voltage to low-voltage line EL. Sub DC/DC converter 40 operates in accordance with a control signal from ECU 41.

ECU 41, communication apparatus 42, auxiliary machinery 43, and auxiliary battery 44 are electrically connected to low-voltage line EL.

Communication apparatus 42 is configured to bidirectionally communicate with communication apparatus 14 of management server 1. Communication apparatus 42 and communication apparatus 14 communicate with each other, for example, wirelessly.

ECU 41 includes a CPU, a memory (a ROM and a RAM), and an input and output port to and from which various signals are provided (none of which is shown). ECU 41 receives input of a signal from each sensor and outputs a control signal to each device, and controls each device. Such control is not limited to processing by software, and processing by constructed dedicated hardware (electronic circuitry) is also applicable.

ECU 41 is configured to calculate a state of charge (SOC) of battery 30. Various known approaches such as an approach by accumulation of current values (coulomb counting) or an approach by estimation of an open circuit voltage (OCV) can be adopted as a method of calculating the SOC.

While vehicle 3 is traveling, ECU 41 transmits position information thereof to management server 1 through communication apparatus 42 in prescribed control cycles. The position information transmitted to management server 1 is used in management server 1 to specify the position of vehicle 3. In requesting power feeding from power feeding lane 5, ECU 41 transmits information on the vehicle ID and information on fed power to management server 1 through communication apparatus 42.

A not-shown position detector is connected to ECU 41. The position detector obtains a current location of vehicle 3, for example, based on a signal (radio waves) from a global positioning system (GPS) satellite. The position detector provides a signal indicating the current location of vehicle 3 (position information) to ECU 41. A method of obtaining the current location of vehicle 3 may be a method of obtaining the current location with the use of a satellite capable of position detection other than the GPS satellite. Alternatively, the method of obtaining the current location of vehicle 3 may be a method of obtaining the current location by transmission and reception of prescribed information to and from a portable base station or an access point of a wireless local area network (LAN).

Input apparatus 49 is further connected to ECU 41. Input apparatus 49 accepts an operation by a user (for example, a driver) in a compartment of vehicle 3. Input apparatus 49 may be implemented, for example, by a touch panel provided on a screen of a display (not shown). Alternatively, input apparatus 49 may be implemented by an operation member such as various buttons.

Auxiliary machinery 43 operates with electric power supplied from low-voltage line EL. Auxiliary machinery 43 includes, for example, a lighting apparatus, a wiper apparatus, an audio apparatus, a navigation apparatus, a power steering apparatus, a meter panel, and a headlight system.

Auxiliary battery 44 is implemented, for example, by a secondary battery such as a lead acid battery or a lithium ion battery. A voltage of auxiliary battery 44 is lower than a voltage of battery 30, and it is, for example, around 12 V. The voltage of auxiliary battery 44 is not limited to a voltage around 12 V, and, for example, any voltage between 12 V and 48 V may be adopted.

Vehicle 3 further includes power reception apparatus 45, a charging relay 47, and a DC/DC converter 48 as features for wireless charging.

DC/DC converter 48 is electrically connected between power reception apparatus 45 and power lines PL and NL. DC/DC converter 48 converts a voltage of DC power received from power reception apparatus 45 into a voltage for charging of battery 30 in accordance with a control signal from ECU 41.

Charging relay 47 is a relay for electrical connection/disconnection between power reception apparatus 45 and DC/DC converter 48. Charging relay 47 switches between a closed state and an open state in accordance with a control signal from ECU 41.

Power reception apparatus 45 is arranged, for example, on a lower surface of a floor panel of vehicle 3, Power reception apparatus 45 includes power reception coil 46. Power reception coil 46 wirelessly receives electric power transmitted from power transmission apparatus 50. Power reception apparatus 45 rectifies electric power transmitted from power transmission apparatus 50 and provides resultant electric power to charging relay 47. A detailed configuration of power reception apparatus 45 and power transmission apparatus 50 will be described later.

Referring to FIG. 1, power feeding lane 5 includes a plurality of power transmission apparatuses 50 and an AC power supply 52. Though FIG. 1 shows an example in which four power transmission apparatuses 50 are included in power feeding lane 5, the number of power transmission apparatuses 50 included in power feeding lane 5 is not limited to four. Power feeding lane 5 may include three or less or five or more power transmission apparatuses 50. Power transmission apparatuses 50 are arranged in line, for example, along a direction of travel of vehicle 3 in a predetermined section of a lane on road 6.

AC power supply 52 is, for example, a commercial system power supply. Each power transmission apparatus 50 receives supply of electric power from AC power supply 52. Each power transmission apparatus 50 includes power transmission coil 51, Power transmission apparatus 50 is configured to switch between activation and deactivation in accordance with a control signal from management server 1. Management server 1 controls the plurality of power transmission apparatuses 50 to be active (turned on) when it receives a power feeding request from vehicle 3. When each power transmission apparatus 50 is activated, it forms electromagnetic field around power transmission coil 51 with AC power supplied from AC power supply 52. Management server 1 controls the plurality of power transmission apparatuses 50 such that each power transmission apparatus 50 is inactive (which is denoted as off below) after vehicle 3 has passed through power feeding lane 5. Management server 1 may determine that vehicle 3 has passed through power feeding lane 5, for example, when electric power is transmitted from none of the plurality of power transmission apparatuses 50 included in power feeding lane 5 (transmitted power is equal to or lower than a threshold value).

FIG. 3 is a diagram for illustrating an exemplary configuration of power transmission apparatus 50 and power reception apparatus 45. Power transmission apparatus 50 includes, for example, a power factor correction (PFC) circuit 510, an inverter circuit 520, a filter circuit 530, a power transmission unit 540, communication apparatus 550, and a controller 560. Power transmission unit 540 includes power transmission coil 51. Power reception apparatus 45 includes a power reception unit 451, a filter circuit 452, and a rectifier 453. Power reception unit 451 includes power reception coil 46.

PFC circuit 510 rectifies and boosts AC power supplied from AC power supply 52 and supplies resultant AC power to inverter circuit 520. Inverter circuit 520 converts electric power rectified by RFC circuit 510 into AC power and provides resultant AC power. AC power provided from inverter 520 is supplied to power transmission unit 540 through filter circuit 530. Each of power transmission unit 540 and power reception unit 451 includes a resonance circuit and is designed to resonate at a frequency of transmitted power.

When AC power is supplied from inverter circuit 520 through filter circuit 530 to power transmission unit 540, magnetic field is formed between power transmission coil 51 of power transmission unit 540 and power reception coil 46 of power reception unit 451. Energy (electric power) moves from power transmission coil 51 to power reception coil 46 through this magnetic field. Filter circuit 452 removes noise in energy (electric power) that has moved to power reception coil 46, and a rectifier 453 converts resultant energy (electric power) from AC power to DC power. Resultant DC power is then supplied to DC/DC converter 48 through charging relay 47.

Communication apparatus 550 of power transmission apparatus 50 is configured to bidirectionally communicate with communication apparatus 14 of management server 1.

Controller 560 of power transmission apparatus 50 includes a CPU, a memory, and an input and output port for input and output of various signals (none of which is shown). Controller 560 controls various devices in power transmission apparatus 50. For example, controller 560 controls PFC circuit 510 and inverter circuit 520 to operate to supply electric power indicated in information on fed power, in accordance with a control signal from management server 1. As PFC circuit 510 and inverter circuit 520 operate, electromagnetic field is formed around power transmission coil 51.

According to the configuration as above, in wireless charging system 100 according to the present embodiment, for example, when a user desires wireless charging of battery 30 while vehicle 3 travels along power feeding lane 5, the vehicle transmits a power feeding request to management server 1. When management server 1 receives the power feeding request from vehicle 3 that travels along power feeding lane 5, it controls the plurality of power transmission apparatuses 50 such that each of the plurality of power transmission apparatuses 50 is on. Electric power is thus wirelessly supplied from power transmission apparatuses 50 in power feeding lane 5 to vehicle 3 (power reception apparatus 45). Battery 30 of vehicle 3 is charged with this electric power.

Vehicle 3 may determine that it is traveling along power feeding lane 5, for example, when the position thereof based on position information is within power feeding lane 5. Alternatively, when vehicle 3 detects variation in magnetic field in power reception apparatus 45 due to passage through power feeding lane 5, it may determine that it is traveling along power feeding lane 5. Alternatively, when the plurality of power transmission apparatuses transmit, for example, minimum electric power and power reception apparatus 45 receives electric power equal to or more than a threshold value, vehicle 3 may determine that it is traveling along power feeding lane 5.

Vehicle 3 transmits, for example, information including position information thereof, the vehicle ID, and information on fed power as the power feeding request to management server 1.

In wireless charging system 100 thus configured, vehicle 3 that is traveling along power feeding lane 5 may change the lane, for example, for passing or the like. At this time, the vehicle may move from a lane where power feeding lane 5 is placed to a lane where power feeding lane 5 is not placed and thereafter return to power feeding lane 5 in the original lane.

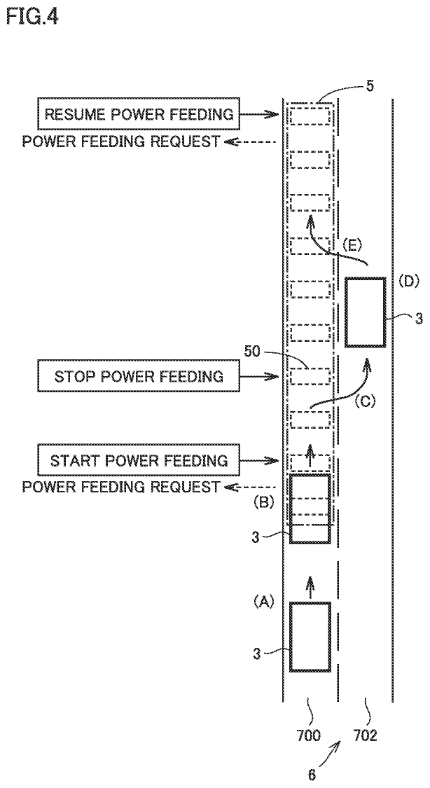

FIG. 4 is a diagram for illustrating an exemplary operation of vehicle 3 that is traveling along power feeding lane 5. FIG. 4 shows road 6 including a first lane 700 and a second lane 702 in the same direction as first lane 700 that is set adjacently to first lane 700. Power feeding lane 5 is set in a predetermined section of first lane 700. The power feeding lane is not set in second lane 702. Power feeding lane 5 is composed of a plurality of power transmission apparatuses 50,

As shown with (A) in FIG. 4, an example in which vehicle 3 is traveling along first lane 700 is assumed. At this time, vehicle 3 is assumed as being located, for example, at a position forward from power feeding lane 5 when facing the direction of travel thereof.

As shown with (B) iii FIG. 4, when vehicle 3 moves from the position shown with (A) in FIG. 4 to a position shown with (B) in FIG. 4, it enters a section where power feeding lane 5 is placed in first lane 700. When vehicle 3 enters, for example, power feeding lane 5, it asks a user whether or not to carry out wireless charging of battery 30 through a display or by voice. When the user performs an operation to transmit the power feeding request, the vehicle transmits the power feeding request to management server 1. Management server 1 turns on each of the plurality of power transmission apparatuses 50 in response to the power feeding request from vehicle 3 to thereby start power feeding. Therefore, power reception apparatus 45 of vehicle 3 receives electric power supplied from opposing power transmission apparatus 50. Battery 30 mounted on vehicle 3 is wirelessly charged with received electric power.

As shown with (C) in FIG. 4, when vehicle 3 moves from first lane 700 to second lane 702, there is no object that receives electric power transmitted from power transmission apparatus 50. Therefore, electric power is no longer transmitted from power transmission apparatus 50. As no electric power is transmitted, management server 1 controls each of the plurality of power transmission apparatuses 50 to turn off to thereby stop power feeding.

As shown with (D) in FIG. 4, while vehicle 3 is traveling along second lane 702, a state that power feeding is stopped is maintained. Then, as shown with (E) in FIG. 4, an example in which vehicle 3 returns from second lane 702 to first lane 700 is assumed.

In this case, when an inquiry about whether or not to carry out wireless charging is issued again to the user at the time when vehicle 3 returns to power feeding lane 5, an operation by the user to transmit the power feeding request may be delayed, which may require time before power transmission apparatus 50 is turned on. Therefore, an amount of electric power received from power feeding lane 5 may be lower than expected.

In the present embodiment, management server 1 is assumed to operate as below. Specifically, when management server 1 receives the vehicle ID as the first identification information from vehicle 3 that moves from first lane 700 where it receives electric power from power feeding lane 5 to second lane 702, it stops power transmission by the plurality of power transmission apparatuses SO to power reception apparatus 45 of vehicle 3 that has transmitted the first identification information. When management server 1 receives the vehicle ID as the second identification information from vehicle 3 that returns from second lane 702 to power feeding lane S in first lane 700 and when the second identification information matches with the first identification information, it resumes power transmission by the plurality of power transmission apparatuses 50 to power reception apparatus 45 of vehicle 3 that has transmitted the second identification information.

Thus, when vehicle 3 temporarily deviates from power feeding lane 5 and thereafter returns to power feeding lane 5, the management server receives the second identification information that matches with the first identification information received at the time when the vehicle temporarily deviated from power feeding lane 5. Power transmission from power feeding lane 5 to power reception apparatus 45 is thus resumed without reception of the power feeding request again. Therefore, charging of battery 30 mounted on vehicle 3 can be resumed with good responsiveness.

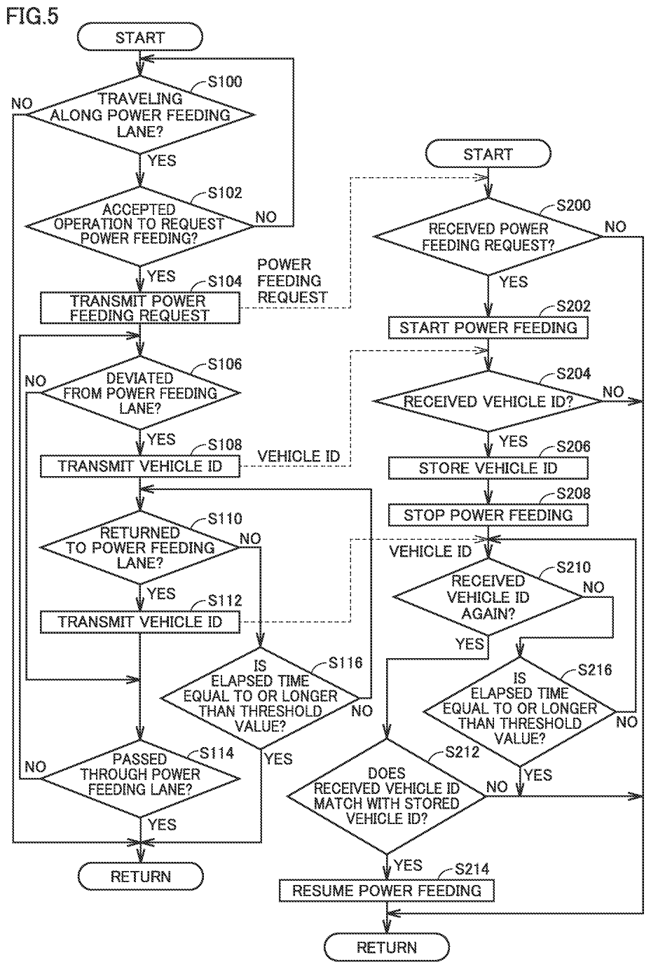

Exemplary processing performed in each of management server 1 and vehicle 3 will be described below with reference to FIG. 5. FIG. 5 is a flowchart showing exemplary processing performed in each of management server 1 and vehicle 3. A series of processing shown in this flowchart is repeatedly performed every prescribed control cycle. The flowchart showing exemplary processing performed by ECU 41 of vehicle 3 is shown on the left in FIG. 5. The flowchart showing exemplary processing performed by controller 10 of management server 1 is shown on the right in FIG. 5. As shown in the flowchart on the left in FIG. 5, in step (the step being denoted as S below) 100, ECU 41 of vehicle 3 determines whether or not vehicle 3 is traveling along power feeding lane 5. Since the method of determining whether or not vehicle 3 is traveling along power feeding lane 5 is as described above, detailed description thereof will not be repeated. When vehicle 3 is determined as traveling along power feeding lane 5 (YES in S100), the process moves to S102.

In S102, ECU 41 determines whether or not an operation to transmit the power feeding request has been performed. For example, when vehicle 3 is determined as traveling along power feeding lane 5, ECU 41 asks the user of vehicle 3 whether or not to carry out charging of battery 30 by wireless charging. For example, ECU 41 controls a display (not shown) provided in the compartment of vehicle 3 to show an inquiry about whether or not to carry out wireless charging. When an operation indicating wireless charging onto input apparatus 49 is accepted, ECU 41 determines that the operation to transmit the power feeding request has been performed. When it is determined that the operation to transmit power feeding has been performed (YES in S102), the process moves to S104.

in S104, ECU 41 transmits the power feeding request to management server 1. The power feeding request includes, for example, the vehicle ID, position information of vehicle 3, and information on fed power as described above.

In S106, ECU 41 determines whether or not vehicle 3 has deviated from power feeding lane 5. For example, when electric power received from power feeding lane 5 by power reception apparatus 45 becomes equal to or lower than a threshold value, when an amount of received electric power per unit time by power reception apparatus 45 becomes equal to or smaller than a threshold value, or when an amount of decrease in received power or amount of received power per unit time becomes equal to or larger than a threshold value, ECU 41 determines that vehicle 3 has deviated from power feeding lane 5. Received power may be detected, for example, by a voltage sensor and a current sensor (not shown) provided in power reception apparatus 45. The threshold value may be set, for example, to a predetermined amount. ECU 41 may determine whether or not vehicle 3 has deviated from power feeding lane 5, for example, based on position information of vehicle 3. For example, when the position of vehicle 3 is within the second lane, ECU 41 may determine that the vehicle has deviated from power feeding lane 5. When vehicle 3 is determined as having deviated from power feeding lane 5 (YES in S106), the process moves to S108.

In S108, ECU 41 transmits the vehicle ID as the first identification information to management server 1. Since the vehicle ID is as described above, detailed description thereof will not be repeated.

In S110, ECU 41 determines whether or not vehicle 3 has returned to power feeding lane 5. For example, when electric power received from power feeding lane 5 by power reception apparatus 45 becomes higher than a threshold value or when electric power received per unit time by power reception apparatus 45 becomes higher than a threshold value, ECU 41 determines that vehicle 3 has returned to power feeding lane 5. The threshold value may be set, for example, to a predetermined amount. For example, ECU 41 may determine whether or not vehicle 3 has returned to power feeding lane 5 based on position information of vehicle 3. For example, when the position of vehicle 3 is within power feeding lane 5, ECU 41 may determine that the vehicle has returned to power feeding lane 5. When vehicle 3 is determined as having returned to power feeding lane 5 (YES in S110), the process moves to S112.

In S112, ECU 41 transmits the vehicle ID as the second identification information to management server 1. The vehicle ID is the same as the vehicle ID transmitted to management server 1 in S108.

In S114, ECU 41 determines whether or not vehicle 3 has passed through power feeding lane 5. For example, when time elapsed since a time point of determination that the vehicle is traveling along power feeding lane 5 is equal to or longer than a threshold value or when received power or the amount of received power decreases more abruptly than in change of the lane (for example, an amount of decrease in received power or amount of received power per unit time becomes equal to or larger than a threshold value), ECU 41 determines that vehicle 3 has passed through power feeding lane 5. ECU 41 may determine whether or not vehicle 3 has passed through power feeding lane 5, for example, based on position information of vehicle 3. For example, when the position of vehicle 3 is within first lane 700 but the position is beyond power feeding lane 5, ECU 41 may determine that vehicle 3 has passed through power feeding lane 5. When vehicle 3 is determined as having passed through power feeding lane 5 (YES in S114), this process ends. When vehicle 3 is determined as not having passed through power feeding lane 5 (NO in S114), the process returns to S106. When the vehicle is determined as not having returned to power feeding lane 5 (NO in S110), the process moves to S116.

In S116, ECU 41 determines whether or not time elapsed since the time point of determination that vehicle 3 has deviated from power feeding lane 5 is equal to or longer than a threshold value. The threshold value is, for example, a value for determining that vehicle 3 has traveled to a position where it is unable to return to power feeding lane 5 when it continues traveling along second lane 702 from the time point when vehicle 3 is determined as having deviated from power feeding lane 5 (a position in second lane 702 beyond power feeding lane 5 even though the vehicle returns to first lane 700). The threshold value is set, for example, based on a speed of vehicle 3 and a distance from a position where the vehicle deviated from power feeding lane 5 to a position where the vehicle is unable to return to power feeding lane 5. When time elapsed since the time point of determination that vehicle 3 deviated from power feeding lane 5 is determined as being equal to or longer than the threshold value (YES in S116), this process ends.

When vehicle 3 is determined as not traveling along power feeding lane 5 (NO in S100), this process ends. When it is determined that the operation to transmit the power feeding request has not been performed (NO in S102), the process returns to S100. When vehicle 3 is not determined as having deviated from power feeding lane 5 (NO in S106), the process moves to S114. When time elapsed since the time point of determination that vehicle 3 deviated from power feeding lane 5 is determined as being shorter than the threshold value (NO in S116), the process returns to S110.

As shown in the flowchart on the right in FIG. 5, in S200, management server 1 determines whether or not it has received the power feeding request from vehicle 3. When the management server is determined as having received the power feeding request (YES in S200), the process moves to S202.

In S202, management server 1 starts power feeding from power feeding lane 5. Specifically, management server 1 turns on each of the plurality of power transmission apparatuses 50 included in power feeding lane 5.

In S204, management server 1 determines whether or not it has received. the vehicle ID. Management server 1 determines whether or not it has received the vehicle ID of vehicle 3 which is a sender of the power feeding request. When the management server is determined as having received the vehicle ID (YES in S204), the process moves to S206.

In S206, management server 1 has the received vehicle ID stored in storage 12 as the first identification information.

In S208, management server 1 stops power feeding from power feeding lane 5. Specifically, management server 1 turns off each of the plurality of power transmission apparatuses 50 included in power feeding lane 5.

In S210, management server 1 determines whether or not it has received the vehicle ID (second identification information) again. When the management server is determined as having received the vehicle ID again (YES in S210), the process moves to S212. When the management server is determined as not having received the vehicle ID again (NO in S210), the process moves to S216.

In S212, management server 1 determines whether or not the vehicle ID received as the second identification information matches with the vehicle ID stored in storage 12 as the first identification information. When the received ID is determined as matching with the stored vehicle ID (YES in S212), the process moves to 5214.

In S214, management server 1 resumes power feeding from power feeding lane 5. Specifically, management server 1 turns on each of the plurality of power transmission apparatuses 50 included in power feeding lane 5.

In S216, management server 1 determines whether or not time elapsed since reception of the vehicle ID is equal to or longer than a threshold value. The threshold value is a value, for example, for determining that vehicle 3 has traveled to a position where it is unable to return to power feeding lane 5 when it continues traveling along second lane 702 after it deviated from power feeding lane 5 (that is, the vehicle ID was received). For example, a value equal to or larger than time required for vehicle 3 to pass through power feeding lane 5 after it enters power feeding lane 5 is set as the threshold value. When the elapsed time is determined as being equal to or longer than the threshold value (YES in S216), the process ends. When the elapsed time is determined as being shorter than the threshold value (NO in S216), the process returns to S210.

When the management server is determined as not having received the power feeding request (NO in S200), when the management server is determined as not having received the vehicle ID (NO in S204), or when the received vehicle ID is determined as not matching with the stored vehicle ID (NO in S212), the process ends.

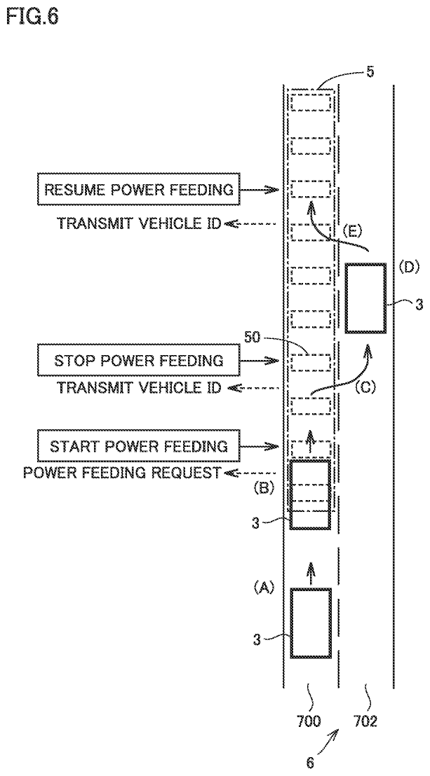

An exemplary operation of management server 1 and vehicle 3 in the present embodiment, based on the structure and the flowchart as above, will be described with reference to FIG. 6. FIG. 6 is a diagram for illustrating exemplary operations of management server 1 and vehicle 3.

FIG. 6 shows road 6 including first lane 700 and second lane 702 in the same direction as first lane 700 that is set adjacently to first lane 700. Power feeding lane 5 is set in a predetermined section in first lane 700. Power feeding lane 5 is composed of the plurality of power transmission apparatuses 50.

As shown with (A) in FIG. 6, an example in which vehicle 3 is traveling along first lane 700 is assumed. At this time, vehicle 3 is assumed as being located, for example, at a position forward from power feeding lane 5 when facing the direction of travel thereof.

As shown with (B) in FIG. 6, when vehicle 3 moves from the position shown with (A) in FIG. 6 to a position shown with (B) in FIG. 6, the vehicle enters the section where power feeding lane 5 is placed in first lane 700. When the vehicle is determined as traveling along power feeding lane 5 (YES in S100) and when the user of vehicle 3 performs an operation to transmit the power feeding request (YES in S102), the power feeding request is transmitted to management server 1 (S104).

When management server 1 receives the power feeding request from vehicle 3 (YES in S200), each of the plurality of power transmission apparatuses 50 is turned on and power feeding from power feeding lane 5 is started (S202).

As power feeding is started, power reception apparatus 45 of vehicle 3 receives electric power transmitted from power transmission apparatus 50 at a position corresponding to power reception apparatus 45 and received power is supplied to battery 30, so that battery 30 is wirelessly charged.

As shown with (C) in FIG. 6, when vehicle 3 moves from first lane 700 to second lane 702, ECU 41 of vehicle 3 determines that vehicle 3 has deviated from power feeding lane 5 (YES in S106). Then, the vehicle ID is transmitted as the first identification information to management server 1 (S108).

When management server 1 receives the vehicle ID from vehicle 3, it has the received vehicle TD stored as the first identification information in storage 12 (S206) and stops power feeding (S208). In other words, management server 1 controls each of the plurality of power transmission apparatuses 50 to turn off.

As shown with (D) in FIG. 6, when vehicle 3 is traveling along second lane 702, vehicle 3 is determined as not having returned to power feeding lane 5 (NO in S110). At this time, when time elapsed since the time point of determination that the vehicle deviated from power feeding lane 5 is determined as being shorter than the threshold value (NO in S116), determination as to whether or not vehicle 3 has returned to power feeding lane 5 is repeatedly made (S110).

As shown with (E) in FIG. 6, when vehicle 3 moves from second lane 702 to power feeding lane 5 in first lane 700, vehicle 3 is determined as having returned to power feeding lane 5 (YES in S110). Then, the vehicle ID is again transmitted as the second identification information (S112). When management server 1 receives the vehicle ID again (YES in 5210), it determines whether or not the received vehicle ID matches with the vehicle ID stored in storage 12 (S212). When the received vehicle ID is determined as matching with the stored vehicle ID (YES in S212), the plurality of power transmission apparatuses 50 included in power feeding lane 5 are turned on and power feeding to power reception apparatus 45 is resumed (S214).

As set forth above, according to the wireless charging apparatus in the present embodiment, when vehicle 3 temporarily deviates from power feeding lane 5 and thereafter returns to power feeding lane 5, the management server receives the vehicle ID (second identification information) that matches with the vehicle ID (first identification information) received at the time of temporary deviation of the vehicle from power feeding lane 5. Power transmission from power feeding lane 5 to power reception apparatus 45 is thus resumed without reception of the power feeding request again. Therefore, charging of battery 30 mounted on vehicle 3 can be resumed with good responsiveness. Therefore, the wireless charging apparatus, the wireless charging method, and the wireless charging system that resume power feeding with good responsiveness when the electrically powered vehicle that travels as temporarily deviating from the power feeding lane returns to the power feeding lane can be provided.

A modification will be described below.

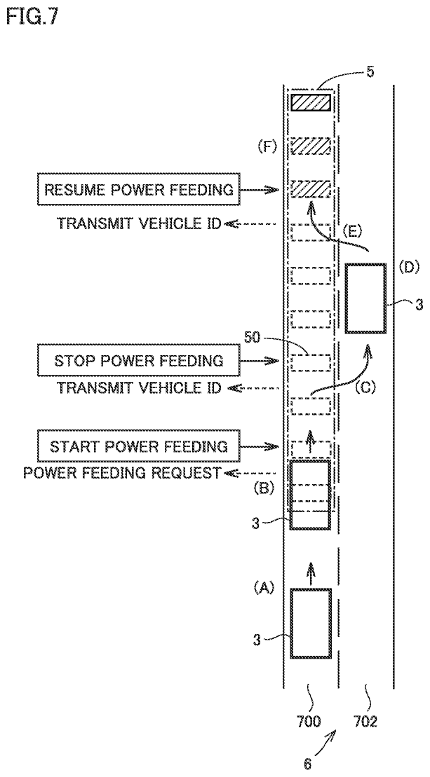

The embodiment above describes that each of the plurality of power transmission apparatuses 50 included in power feeding lane 5 is turned on when the vehicle ID received as the second identification information matches with the vehicle ID stored as the first identification information. For example, however, management server 1 may turn on power transmission apparatuses 50 from a point where vehicle 3 returns to power feeding lane 5. FIG. 7 is a diagram for illustrating exemplary operations of management server 1 and vehicle 3 in the modification. Since operations of management server 1 or vehicle 3 shown with (A) to (E) in FIG. 7 are similar to the operations of management server 1 or vehicle 3 shown with (A) to (E) in FIG. 6, detailed description thereof will not be repeated.

When the received vehicle ID is determined as matching with the stored vehicle ID, management server 1 specifies the position of vehicle 3 in power feeding lane 5 by obtaining position information from vehicle 3 or by turning on each of the plurality of power transmission apparatuses 50 to obtain a position of power transmission apparatus 50 where electric power is transmitted to power reception apparatus 45. Management server 1 turns on only power transmission apparatuses 50 on a side of the direction of travel of vehicle 3 relative to the specified position and turns off other power transmission apparatuses 50. For example, as shown with (F) in FIG. 7, management server 1 specifies the position of vehicle 3 in power feeding lane 5, and turns on only power transmission apparatuses (power transmission apparatuses 50 shown with hatching in FIG. 7) located on the side of the direction of travel of vehicle 3 relative to the specified position and turns off other power transmission apparatuses 50. Thus, a power transmission operation of power transmission apparatus 50 over which vehicle 3 that has returned to power feeding lane 5 does not pass, among the plurality of power transmission apparatuses 50, can be stopped. Therefore, increase in amount of power consumption can be suppressed.

The embodiment above describes that, when management server 1 receives the power feeding request, it controls the plurality of power transmission apparatuses 50 to turn on. Management server 1, however, may adjust transmitted power, for example, based on information on fed power received from vehicle 3. For example, when an upper limit value of received power in power reception apparatus 45 of vehicle 3 is smaller than an upper limit value of fed power of power transmission apparatus 50, management server 1 may control the plurality of power transmission apparatuses 50 such that received power at the upper limit value is transmitted.

The embodiment above describes that ECU 41 transmits the power feeding request to management server 1 by accepting an operation by the user to issue the power feeding request. For example, when power feeding lane 5 is set in advance to be included in a path for moving to a destination for charging along power feeding lane 5 during a period until movement to the destination, ECU 41 may transmit the power feeding request to management server 1 before it receives the operation by the user at the time of entry of vehicle 3 in power feeding lane 5.

The embodiment above describes that management server 1 and vehicle 3 are configured to communicate with each other. Each of the plurality of power transmission apparatuses 50 and vehicle 3, however, may be configured to communicate with each other. Thus, each of the plurality of power transmission apparatuses 50 can detect whether or not vehicle 3 has passed. Therefore, power transmission apparatus 50 that can transmit electric power to vehicle 3 when vehicle 3 passes through power feeding lane 5 can be turned on. Power transmission apparatuses 50 to be turned on as vehicle 3 travels along power feeding lane 5 can thus be switched.

The embodiment above describes that management server 1 controls the plurality of power transmission apparatuses 50 included in power feeding lane 5. For example, however, management server 1 may control a plurality of power transmission apparatuses included in another power feeding lane, in addition to the plurality of power transmission apparatuses 50 included in power feeding lane 5.

The entirety or a part of the modification may be carried out as being combined as appropriate.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A wireless charging apparatus configured to wirelessly charge a power storage mounted on an electrically powered vehicle, the electrically powered vehicle including a power reception apparatus that receives electric power from the wireless charging apparatus, the wireless charging apparatus comprising:
a power feeding lane placed along a first lane, the power feeding lane being composed of a plurality of power transmission apparatuses that transmit electric power to the power reception apparatus of the electrically powered vehicle that travels along the first lane; and
a controller that controls the plurality of power transmission apparatuses to transmit electric power to the power reception apparatus of the electrically powered vehicle that travels along the power feeding lane when the controller receives a power feeding request from the electrically powered vehicle, wherein
the controller
stops power transmission by the plurality of power transmission apparatuses to the power reception apparatus of the electrically powered vehicle that has transmitted first identification information on which identification of the electrically powered vehicle can be based, when the controller receives the first identification information from the electrically powered vehicle that moves from the first lane where the electrically powered vehicle receives electric power from the power feeding lane to a second lane where the power transmission apparatuses are not placed, and
resumes power transmission by the plurality of power transmission apparatuses to the power reception apparatus of the electrically powered vehicle that has transmitted second identification information on which identification of the electrically powered vehicle can be based, when the controller receives the second identification information from the electrically powered vehicle that returns from the second lane to the power feeding lane in the first lane and when the second identification information matches with the first identification information.

2. The wireless charging apparatus according to claim 1, wherein
when the controller resumes power transmission to the power reception apparatus by the plurality of power transmission apparatuses, the controller resumes power transmission to the power reception apparatus with power transmission apparatuses from a point where the electrically powered vehicle returns to the power feeding lane among the plurality of power transmission apparatuses.

3. A wireless charging method of wirelessly charging a power storage mounted on an electrically powered vehicle that travels along a power feeding lane placed along a first lane and composed of a plurality of power transmission apparatuses, the electrically powered vehicle including a power reception apparatus that receives electric power from the power feeding lane, the wireless charging method comprising:
controlling the plurality of power transmission apparatuses to transmit electric power to the power reception apparatus of the electrically powered vehicle that travels along the power feeding lane in response to reception of a power feeding request from the electrically powered vehicle;
stopping power transmission by the plurality of power transmission apparatuses to the power reception apparatus of the electrically powered vehicle that has transmitted first identification information on which identification of the electrically powered vehicle can be based, when the first identification information is received from the electrically powered vehicle that moves from the first lane where electric, power is received from the power feeding lane to a second lane where the power transmission apparatuses are not placed; and
resuming power transmission by the plurality of power transmission apparatuses to the power reception apparatus of the electrically powered vehicle that has transmitted second identification information on which identification of the electrically powered vehicle can be based, when the second identification information is received from the electrically powered vehicle that returns from the second lane to the power feeding lane in the first lane and when the second identification information matches with the first identification information.

4. The wireless charging method according to claim 3, further comprising resuming power transmission to the power reception apparatus with power transmission apparatuses from a point where the electrically powered vehicle returns to the power feeding lane among the plurality of power transmission apparatuses, when power transmission to the power reception apparatus by the plurality of power transmission apparatuses is resumed.

5. A wireless charging system comprising:
a power feeding lane placed along a first lane and composed of a plurality of power transmission apparatuses;
an electrically powered vehicle including a power reception apparatus that receives electric power from the power feeding lane and a power storage configured to be chargeable with received electric power; and
a controller that controls the plurality of power transmission apparatuses to transmit electric power to the power reception apparatus of the electrically powered vehicle that travels along the power feeding lane when the controller receives a power feeding request from the electrically powered vehicle, wherein
when the electrically powered vehicle moves from the first lane where the electrically powered vehicle receives electric power from the power feeding lane to a second lane where the power transmission apparatuses are not placed, the electrically powered vehicle transmits first identification information on which identification of the electrically powered vehicle can be based to the controller,
when the controller receives the first identification information, the controller stops power transmission by the plurality of power transmission apparatuses to the power reception apparatus of the electrically powered vehicle that has transmitted the first identification information,
when the electrically powered vehicle returns from the second lane to the power feeding lane in the first lane, the electrically powered vehicle transmits second identification information on which identification of the electrically powered vehicle can be based to the controller, and
when the controller receives the second identification information and when the second identification information matches with the first identification information, the controller resumes power transmission by the plurality of power transmission apparatuses to the power reception apparatus of the electrically powered vehicle that has transmitted the second identification information.

6. The wireless charging system according to claim 5, wherein
when the controller resumes power transmission to the power reception apparatus by the plurality of power transmission apparatuses, the controller resumes power transmission to the power reception apparatus with power transmission apparatuses from a point where the electrically powered vehicle returns to the power feeding lane among the plurality of power transmission apparatuses.
